(19) United States
(12) Patent Application Publication
(10) Pub. No.: US 2010/0192717 A1
(43) Pub. Date: Aug. 5, 2010

(54) Variable-speed gear wheel transmission

(76) Inventor: Carstem Gitt, Stuttgart (DE)

Correspondence Address: KLAUS J. BACH, 4407 TWIN OAKS DRIVE, MURRYSVILLE, PA, 15668, US

(21) Appl. No.: 12/660,337

(22) Filed: Feb. 24, 2010

Related U.S. Application Data
(63) Continuation-in-part of application No. PCT/EP2008/006973, filed on Aug. 26, 2008.

(30) Foreign Application Priority Data
Aug. 28, 2007 (DE) 10 2007 040 449.4

(51) Int. Cl. F16H 3/087

(52) U.S. Cl. 74/330

(57) ABSTRACT

In a gear shift transmission comprising at least two input shafts, which can be connected to a drive shaft via at least two power shift clutches and a plurality of gear wheels disposed in gear wheel planes and comprising an output shaft, which can be operatively connected to the input shafts, the transmission includes at least two sequentially shiftable forward gears and a shifting device, which is provided for shifting one of the gear wheel planes as an input constant for forming at least one gear and as a gear wheel pair for forming a further gear and the gear wheel plane comprises an idler wheel which is connectable to one of the input shafts in a torque proof manner.

This is a Continuation-In-Part application of pending international patent application PCT/EP2006973 filed Aug. 26, 2008 and claiming the priority of German patent application 10 2007 040 449.4 filed Aug. 28, 2007.

### BACKGROUND OF THE INVENTION

The invention relates to a gear shift transmission having two input shafts which can be connected to a drive shaft by way of two power shift clutches.

WO 00/39484 discloses a gear shift transmission with two input shafts, which can be connected to a drive shaft via two power shift clutches.

It is the object of the present invention to provide a compact gear shift transmission with an as high as possible number of sequentially shiftable gears.

### SUMMARY OF THE INVENTION

In a gear shift transmission comprising at least two input shafts, which can be connected to a drive shaft via at least two power shift clutches and a plurality of gear wheels disposed in gear wheel planes and comprising an output shaft, which can be operatively connected to the input shafts, the transmission includes at least two sequentially shiftable forward gears and a shifting device, which is provided for shifting one of the gear wheel planes as an input constant for forming at least one gear and as a gear wheel pair for forming a further gear and the gear wheel plane comprises an idler wheel which is connectable to one of the input shafts in a torque proof manner.

An “input shaft” is meant to be a shaft via which a drive torque is initiated in the variable-speed gear wheel transmission. An “input constant” is especially meant to be a gear wheel plane with at least two gear wheels initially arranged in the force flow via which is guided the drive torque in a force flow direction of the drive torque. A “gear wheel pair” is a gear wheel pair with at least two gear wheels following the input constant in the force flow direction. By a design according to the invention, a large number of gears can be realized with a relative low number of gear wheel planes, whereby a gear shift transmission can be provided, with a relatively high number of sequentially shiftable gears and a relatively compact design.

It is thereby suggested that the shifting device comprises a shifting unit which is provided to connect one of the input shafts selectively to one of two idler wheels in a torque-proof manner. “Torque-proof” is intended to mean that the rotational direction and the speed of the parts connected in a torque-proof manner is the same. Thereby, a further input constant can be realized in a simple manner with the same number of input shafts, whereby a number of the gears that can be established is increased.

It is further suggested that the shifting device comprises a further shifting unit, which is provided to connect one of the two idler wheels to the output shaft in a torque-proof manner. A gear wheel plane can thereby be shifted as an input plane and as a gear wheel plane in a particularly simple manner.

It is additionally suggested that one of the idler wheels is rotatably supported with regard to one of the input shafts. With such an arrangement, the corresponding gear wheel plane, which serves especially as an input constant, can be decoupled from the input shaft, and a further gear wheel plane can be shifted as input constant for forming a gear. A mounting on the inner input shaft is thereby particularly advantageous.

It is further advantageous if one of the idler wheels is arranged on the output shaft, as a simple mounting of the idler wheel can be achieved thereby.

The gear wheel plane is advantageously provided as a gear wheel pair for forming two of the forward gears and as an input constant for forming two further forward gears. By a use of the gear wheel plane for several gears a high number of gears can be realized with a low number of gear wheel planes and an installation space of the variable-speed gear wheel transmission can also be provided in a compact manner.

It is further advantageous if a further gear wheel plane is provided for forming three of the forward gears, which is also advantageous for a number of the gear wheel planes.

It is further suggested that a further gear wheel plane is provided as a gear wheel pair for forming two of the forward gears. Especially, if a third gear wheel plane still has a multiple use as a gear wheel pair, a variable-speed gear wheel transmission according to the invention can be realized in an especially compact manner.

It is further suggested that an idler wheel of the first gear wheel plane can be connected to one of the input shafts and to the output shaft in a torque-proof manner for forming a forward gear. A torque-proof connection of the drive shaft to the output shaft can be realized thereby, and a direct gear can be formed in a simple manner.

It is suggested that the variable-speed gear wheel transmission comprises exactly seven gear wheel planes and exactly four shifting units. Such a variable-speed gear wheel transmission can have a low number of gear wheel planes with a large number of realizable gears.

It is further suggested that at least one shifting unit has a shifting collar which can be shifted to both sides, which is provided to connect the shifting unit to two units so as to be rotatable with regard to the shifting unit in a torque-proof manner. Such a shifting unit is especially compact. The shifting unit is advantageously arranged on a shaft in a torque-proof manner, and the units are formed by idler wheels or further shafts. It is especially advantageous if all shifting units are designed in such a manner.

It is suggested that the variable-speed gear wheel transmission comprises nine forward gears, which can be continuously sequentially load-shifted, whereby a high shifting comfort and thus a high customer use is achieved.

It is additionally suggested that the variable-speed gear wheel transmission comprises three reverse gears, which can be continuously sequentially load-shifted, whereby driver convenience is increased.

It is further suggested that at least two step ratios are formed with a different size. A “step ratio” is especially meant to be the ratio of a gear transmission of a gear to a gear transmission of the next higher gear. “Different size” is meant to be a difference of more than 5% between the step ratio. By step ratios formed with a different size, a transmission graduation can be realized which is especially advantageous for passenger vehicles.

It is additionally suggested that all step ratios are smaller in their amount than a step ratio between the second and the third forward gear. Thereby, a starting-up strategy can be realized in which a first gear is used as a strongly high-ratio gear. Thereby, selectively, a first, a second and a third gear can be used for starting up.

It is thereby especially advantageous if all step ratios have a larger amount and/or the same amount as a step ratio between the two highest forward gears. An especially advantageous transmission graduation can be achieved thereby, as the two highest gear transmissions are advantageously close together. A step ratio between the fourth and the fifth forward gear is especially the same as a step ratio between the two highest forward gears, as these two step ratios are principally the same.

It is especially advantageous if all step ratios are larger than the step ratio between the two highest forward gears and a principally same step ratio between the fourth and the fifth forward gear, as a gear graduation with an especially high customer use can be achieved thereby.

As an alternative gear graduation, it is suggested that all step ratios between respectively two adjacent forward gears are formed in an approximately constant manner. “Approximately constant” is meant to be a difference between the step ratios of maximally 5%. A gear graduation with step ratios arranged in such a manner is especially advantageous for utility vehicles.

It is further suggested that one end of one of the input shafts which is provided to receive a pilot bearing and/or which faces the output shaft, is designed as a hollow shaft. A “pilot bearing” is especially meant to be a bearing which connects one of the input shafts, especially the inner input shaft, to the output shaft in a rotatable manner. An especially stable mounting can be achieved by a far mounting on the input side of the two shafts. A roller bearing is especially advantageous as a pilot bearing, however, other bearing units appearing sensible to the expert are also conceivable. A simple mounting between one of the input shafts and the output shaft can thereby be realized. One end of the inner input shaft is advantageously also formed as a hollow shaft. One end of the output shaft, which faces the input shafts, can alternatively also be formed as a hollow shaft.

It is further suggested that the pilot bearing is arranged on the input side of the second gear wheel plane. “On the input side” is especially meant to be on the side in the direction of the shifting clutch devices or in the direction of the transmission input. Such a pilot bearing arranged far on the input side and thus a simple mounting can thereby be realized in a simple manner. It is thereby additionally advantageous if the pilot bearing lies on the input side of the first input constant.

It is additionally suggested that the input shaft and the output shaft are mounted relative to each other by an additional bearing. A particularly stable mounting can be realized by an additional bearing in addition to the pilot bearing.

It is further suggested that the variable-speed gear wheel transmission comprises a bearing unit with at least two bearing planes which are provided to mount the input shafts and/or the output shaft. By means of a bearing unit with two planes, a mounting of the shafts in the variable-speed gear wheel transmission can be realized in a simple manner. It is especially advantageous if the countershafts are also mounted by the bearing unit. A mounting of all parts appearing sensible to the expert is possible in principle by means of the bearing unit.

A bearing unit comprising three bearing planes is especially advantageous. A compact and stable mounting of the gear wheel planes can especially be achieved with three bearing planes.

It is thereby suggested that at least one of the bearing planes comprises a support wall, which is connected to a transmission housing in a fixed manner. A support wall is especially stable as a bearing plane. If the transmission housing consists of several parts, it is suggested that the support wall is connected to at least one transmission housing part in a fixed manner.

Furthermore, a method for a variable-shift gear wheel transmission is suggested, in which a shifting logic is adjusted in dependence on shifting processes of shifting units to be expected by means of a control unit, where shifting element actuations from a coupled state into a neutral state and during the next shifting process back into the coupled state are avoided in at least one operating mode, whereby a number of shifting element actuations can be reduced by omitting shifting element actuations of shifting units, which only lead to a rotary decoupling. A wear of the shifting units can thereby especially be reduced and a durability of the variable-shift gear transmission can be increased.

Further, a method is suggested where at least two forward gears are engaged in at least one starting-up mode in a primary starting-up phase and wherein the associated power shift clutches are operated in a slipping manner, so that both power shift clutches and thus both forward gears participate in the transmission of the drive torque. An uneven wear of the power shift clutches can be avoided thereby, It is especially advantageous if a first and a second gear are engaged and the associated power shift clutches are operated in a slipping manner, as the wear of the clutch devices can be minimized thereby, but it is also conceivable that a second and a third gear are engaged and the associated power shift clutches are operated in a slipping manner, whereby a number of shifting processes can be reduced.

It is further advantageous if one of the two power shift clutches is opened successively after the primary starting-up phase, and the other power shift clutch is closed successively, so that only one of the power shift clutches and thus only one of the forward gears participates in the transmission of the drive torque. A long slipping operation leading to a high wear of the power shift clutches is avoided thereby, whereby a variable-speed interval for the power shift clutches can be extended.

It is further suggested that a decision is made and/or implemented by means of a control and/or regulating unit in dependence on at least one characteristic, which of the two power shift clutches is opened successively after the primary starting-up phase and which of the two power shift clutches is successively closed after the primary starting-up phase. A characteristic can thereby especially be formed by a load state characteristic and/or a road inclination characteristic and/or a drive torque requirement characteristic. By such a method by means of a correspondingly designed regulation and/or control unit, an increased customer use can be achieved.

It is additionally suggested that a first or a second forward gear is shifted in at least one starting-up mode in a primary starting-up phase by shifting the associated power shift clutch in a slipping manner, while the other power shift clutch is opened. Such a starting-up mode is also advantageous for the customer use. Especially in driving situations, in which the vehicle is to be guided in a sensitive manner or in which numerous directly successive starting-up processes take place, an advantageous shifting behavior can be achieved thereby.

The invention will become more readily apparent from the following description of a particular embodiment thereof with reference to the accompanying drawings.

### BRIEF DESCRIPTION OF THE DRAWINGS

FIG. 1 shows a schematically a variable-speed gear wheel transmission,

FIG. 2 shows a gear graduation with approximately the same step ratios,

FIG. 3 shows a gear graduation with different step ratios,

FIG. 4 shows numerical values for the gear graduation from FIG. 3,

FIG. 5 shows a shifting logic for the variable-speed gear wheel transmission according to the invention,

FIG. 6 shows an adjusted shifting logic for an acceleration mode, and

FIG. 7 shows a support bearing arrangement for the variable-speed gear wheel transmission according to the invention.

### DESCRIPTION OF A PARTICULAR TRANSMISSION

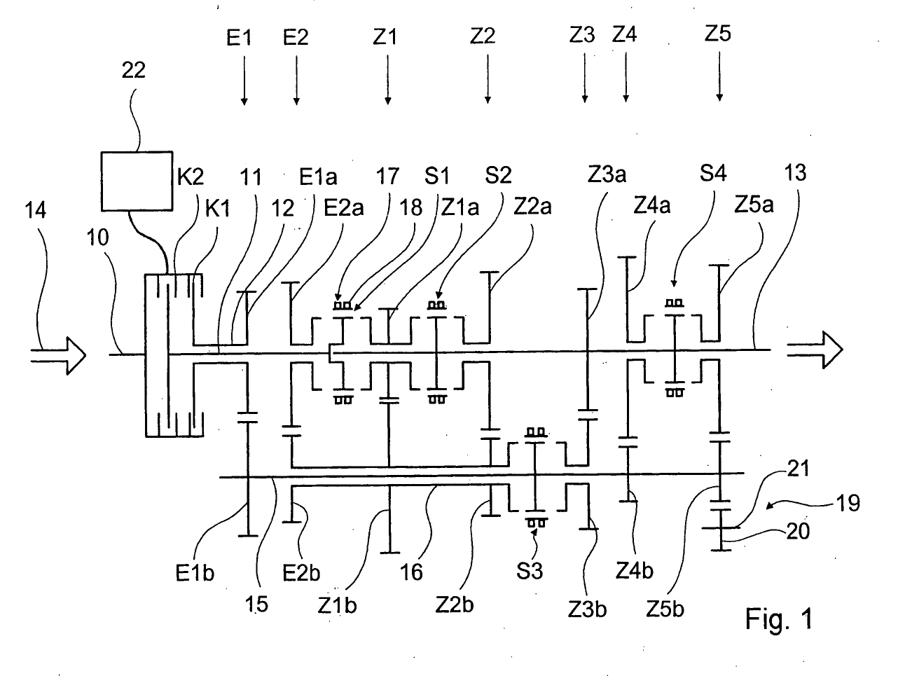

FIG. 1 schematically shows a a variable-speed gear wheel transmission with at least two input shafts 11, 12, which can be connected to a drive shaft 10 via at least two power shift clutches K1, K2, with gear wheels arranged in gear wheel planes E1, E2, Z1-Z5 and with an output shaft 13, which can be operatively connected to the input shafts 11, 12. A bearing support structure of the variable-speed gear wheel transmission is not shown here in detail for simplification.

One of the input shafts 11, which is formed as a solid shaft, is connected to a part of the second power shift clutch K2 for initiating a drive torque 14. The second input shafts 12, which is designed as a hollow shaft, is connected to a part of the first power shift clutch K1 in a torque-proof manner for initiating a drive torque 14.

The two input shafts 11, 12 are designed in a coaxial manner to each other, wherein the inner input shaft 11 designed as a solid shaft passes through the outer input shaft 12 designed as a hollow shaft and is mounted thereon. The output shaft 13 is arranged coaxially to the drive shaft 10 or to the input shafts 11, 12 and is mounted rotatably at one end of the inner input shaft 11 with one end by means of a pilot bearing 23.

For forming gears V1-V9, R1-R3, the gear wheels, which are partially designed as idler wheels E2a, Z1a, Z2a, Z3b, Z4a and Z5a and partially as fixed wheels E1a, E1b, E2b, Z1b, Z2b, Z3a, Z4b, Z5b, 20, are arranged in gear wheel planes E1, E2, Z1-Z5. The gear wheel planes E1, E2, Z1-Z5 partially serve as input constants which are provided to connect the input shafts 11, 12 to countershafts 15, 16, and partially as gear wheel pairs, which are provided to connect the countershafts 15, 16 to the output shaft 13. The gear wheel planes E1, E2, Z1, which serve as input constants, are the gear wheel planes arranged first in a force flow direction of the drive torque 14 during the shifting of a gear. The gear wheel planes E1, E2, Z1 and the gear wheel planes Z1-Z5, which serve as gear wheel planes, are the following gear wheel planes Z1-Z5.

One of the countershafts 15 is designed as a solid shaft, the other countershaft 16 as a hollow shaft. The hollow countershaft 16 and the solid inner countershaft are arranged in a coaxial manner to each other, wherein the inner countershaft 15 passes through the outer countershaft 16 and is supported thereby. The countershafts 15, 16 are arranged parallel to the input shafts 11, 12 or the output shaft 13.

The first gear wheel plane E1 comprises a fixed wheel E1a, which is arranged on the outer input shaft 12, and a fixed wheel E1b, which is arranged on the inner countershaft 15 and cogs with the fixed wheel E1a. The outer input shaft 11 is operatively connected to the inner countershaft 15 via the first gear wheel plane E1, which forms a first input constant for a part of the gears V2, V4, V6, V8, R2.

The second gear wheel plane E2 comprises the idler wheel E2a, which is e.g. slidingly mounted with respect to the inner input shaft 11 and which can be connected to the inner input shaft via the shifting unit S1. The idler wheel E2a cogs with the fixed wheel E2b, which is arranged on the outer countershaft 16. The second gear wheel plane E2 forms a second input constant for further gears V5, V9, R3.

The shifting unit S1, and analogously the shifting units S2, S3, S4, comprises a shifting collar 18, which can be shifted to both sides and which is connected to the inner input shaft 11 in a torque-proof manner. The shifting collar 18 is arranged in an axially displaceable manner. The shifting collar 18 has a neutral position N, in which it is decoupled, and two lateral sliding positions 1, 2, in which it is connected to one of two coupling bodies in a torque-proof manner, not shown in detail, whereby the sliding collar 18 and thus the inner input shaft 11 can optionally be connected to one of two idler wheels E2a, Z1a. The remaining shifting units S2, S3, S4 are constructed analogously to the shifting unit S1, this is why the description of the shifting unit S1 can be referred to with regard to the functionality of the shifting units S3, S4, S5.

The third gear wheel plane Z1 comprises the idler wheel Z1a, which is arranged on the output shaft 13. The idler wheels Z1a can optionally also be connected to the inner input shaft 11 in a torque-proof manner via the shifting unit S1, which can connect the idler wheel E2a to the inner input shaft 11 in a torque-proof manner. The idler wheel Z1a can further be connected to the output shaft 13 in a torque-proof manner via the shifting unit S2. The idler wheel Z1a cogs with the fixed wheel Z1b, which is arranged on the outer countershaft 16. The third gear wheel plane Z1 can be shifted via a shifting device 17, which comprises at least the shifting units S1, but can also comprise the S2, as a first gear wheel pair for forming two of the forward gears V8, V9. The third gear wheel plane Z1 can alternatively be shifted via the shifting units S1 as a third input constant for forming two further forward gears V1, V2.

The fourth gear wheel plane Z2 comprises the idler wheel Z2a, which can be connected to the output shaft 13 via the shifting unit S2 and which cogs with the fixed wheel E2b, which is arranged on the outer countershaft 16. The fourth gear wheel plane Z2 serves a a second gear wheel pair for forming three of the forward gears V3, V4, V5.

The fifth gear wheel pair Z3 comprises the fixed wheel Z3a arranged on the output shaft 13 and the idler wheel Z3b arranged on the outer countershaft 15, which idler wheel can be connected to the outer countershaft 15 via the shifting unit S3. The shifting unit S3 can further connect the outer countershaft 16 to the inner countershaft 15 in a torque-proof manner. The fifth gear wheel plane Z3 serves as the third gear wheel pair for forming the fifth forward gear V5.

The sixth gear wheel plane Z4 comprises the idler wheel Z4a arranged on the output shaft 13, which can be connected to the output shaft 13 by means of the shifting unit S4. The idler wheel Z4a cogs with the fixed wheel Z4b, which is arranged on the inner countershaft 15. The sixth gear wheel plane Z4 serves as a fourth gear wheel pair for forming two of the forward gears V1, V2.

The seventh gear wheel plane Z5 serves for forming the reverse gears R1, R2, R3 and comprises the idler wheel Z5a, the fixed wheel Z5b and a reversing unit 19, by means of which a rotary direction of the output shaft 13 is reversed with the rotary direction of the drive shaft 10 remaining the same when shifting one of the reverse gears R1, R2, R3. The seventh gear wheel plane Z5 comprises the idler wheel Z5a arranged on the output shaft 13, which idler wheel can be connected to the output shaft 13 by means of the shifting unit S4, and the fixed wheel Z5b, which is arranged on the inner countershaft 15. For reversing the rotary direction, the idler wheel Z5a and the fixed wheel Z5b cog with the third gear wheel arranged in the gear wheel plane Z5, which belongs to the reversing unit 19 and which is formed as a fixed wheel 20 on a reversing shaft 21 arranged in a rotary manner.

For forming the forward gear V7, which is designed as a direct gear, the idler wheel Z1a is connected to the inner input shaft 11 via the shifting unit S1 and to the output shaft 13 via the shifting unit S2 in a torque-proof manner.

The variable-speed gear wheel transmission thus comprises exactly seven gear wheel planes E1, E2, Z1-Z5 and exactly four shifting units S1-S34. By means of the gear wheel planes E1, E2, Z1-Z5 and the shifting units S1-S4, nine continuously sequentially load-shiftable forward gears V1-V9 and three continuously sequentially load-shiftable reverse gears R1-R3 can be formed.

A basic property of the variable-speed gear wheel transmission is that a step ratio φ_{1/2} between the first and the second forward gear V1, V2 is identical to a step ratio φ_{3/ 4} between the third and fourth gear V3, V4 and a step ratio φ_{7/8} between the seventh and the eighth forward gear V7, V8. Furthermore, a step ratio φ_{4/5} between the fourth and the fifth forward gear V5 is always the same as a step ratio φ_{8/9} between the eighth and the ninth forward gear V8, V9. All other step ratios φ_{2/3}, φ_{5/6}, φ_{6/7} can be chosen freely without restriction.

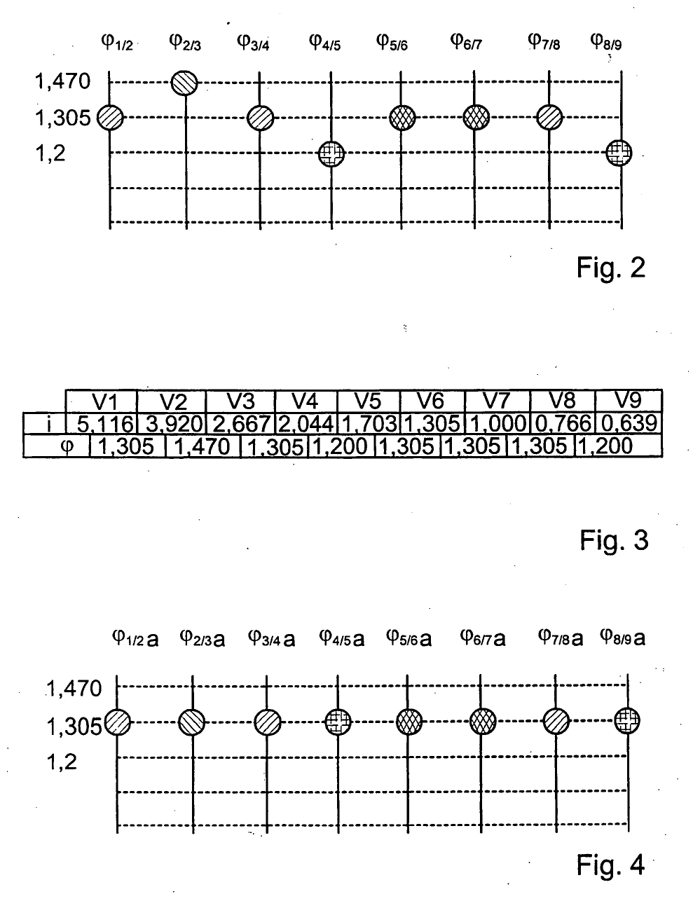

A basically possible graduation φ while considering the step ratios which are principally the same is a graduation φ, where all step ratios φ_{1/2}, φ_{3/4}, φ_{4/5}, φ_{5/6}, φ_{6/7}, φ_{7/8}, φ_{8/9} are smaller in their amount than the step ratio φ_{2/3} between the second and third forward gear V2, V3, as shown in FIG. 2.

In the variable-speed gear wheel transmission according to the invention, all φ_{1/2}, φ_{3/4}, φ_{3/4}, φ_{5/6}, φ_{6/7}, φ_{7/8} step ratios are additionally designed larger than the step ratio φ_{8/9} between the two highest forward gears V8, V9 and the step ratio φ_{4/5} principally of the same size between the fourth and the fifth forward gear V4, V5. The inherently arbitrary step ratios φ_{5/6} and φ_{6/7} are thereby chosen to have the same size as the step ratios φ_{1/2}, φ_{3/4} and φ_{7/8}, basically, another choice of the step ratios φ_{5/6} and φ_{6/7} is however also possible. An exemplary transmission sequence with this graduation φ is given in FIG. 3. A possible gear transmission i of the individual forward gears V1-V9 is additionally given in FIG. 3.

FIG. 4 shows an alternative possible graduation of the variable-speed gear transmission, where all step ratios φ_{1/2}a-φ_{8/9}a are formed in approximately the same manner.

So as to form the first forward gear V1, the inner input shaft 11 is connected to the outer countershaft 16 via the shifting unit S1 and the gear wheel plane Z1, which serves as the input constant. The outer countershaft 16 is connected to the inner countershaft 15 via the shifting unit S3. The inner countershaft 15 is additionally connected to the output shaft 13 via the gear wheel plane Z3 and the shifting unit S3, and the first forward gear V1 is formed.

As a matter of principal, the second forward gear V2 is then already formed, as the outer input shaft 12 is connected to the inner countershaft 15 via the gear wheel plane E1, which counter shaft is already connected to the output shaft 13 by forming the first forward gear V1.

In a primary starting phase of a starting-up mode, the first and the second forward gear V1, V2 are engaged and the associated power shift clutches K2, K1 are operated in a slipping manner, whereby both forward gears V1, V2 participate in the transmission of the drive torque 14. The starting-up thus takes place in a primary phase simultaneously via the forward gears V1 and V2. Such a starting-up mode via both power shift clutches K2, K1 can particularly advantageously be used, as the step ratio φ_{1/ 2} between the first forward gear V1 and the second forward gear V2 is comparatively small, thus for example smaller than the step ratio φ_{2/3} between the forward gears V2 and V3, as the difference speeds which can be realized in the power shift clutches K2 and K1 operated in the slipping manner are comparatively small and thus excessive wear and/or excessive heat input by especially high frictional performances can largely be avoided.

In dependence on one or several characteristics, as for example a load state of the vehicle, an incline or decline of the road, and a drive torque demand by the driver regarding the position of the drive pedal, it is determined after the previously described starting-up phase via the two forward gears V1 and V2 by means of a control unit 22, which of the two power shift clutches K1, K2 will be opened successively after the primary starting-up phase, and which of the two power shift clutches K2, K1 will be closed successively after the primary starting-up phase, so that only one of the power shift clutches K1, K2 and thus only one of the forward gears V2, V1 participates in the transmission of the drive torque 14. For this, either the power shift clutch K1 is closed successively with simultaneous successive opening of the power shift clutch K2, or the power shift clutch K2 is closed successively with simultaneous successive opening of the power shift clutch K1.

Alternatively, starting-up modi are present, in which one shifts a first or a second forward gear V1, V2, depending on the starting-up mode, by operating the associated power shift clutch K1, K2 in a slipping manner, while the other power shift clutch K2, K1 is opened. A decision, which starting-up mode is to be chosen, thereby especially depends on a driver demand and/or on one or several other operating parameters accessible to the control unit and appearing sensible to the expert.

As the first step ratio φ_{1/2} is smaller than the second step ratio φ_{2/3}, a starting-up mode with the first forward gear V1 is especially suitable as starting gear in a stop and go operating mode, or in an operating mode in which a particularly sensitive guiding is necessary. The starting-up mode in the first forward gear V1 is also advantageous with an operating mode with a high load and/or an incline. If an operating mode is given, in which a starting-up mode in the second gear is sufficient, this is chosen.

A starting mode for starting out in the first forward gear independently of operating parameters is also basically conceivable.

So as to shift from the first forward gear V1 to the second forward gear V2 under load, if the first forward gear V1 is shifted, one shifts from the second power shift clutch K2 to the first power shift clutch K1 with simultaneous successive opening of the power shift clutch K2 by closing the power shift clutch K1 by the control unit 22. The shifting units S1 and S2 can subsequently be decoupled in a load-free manner.

So as to form the third forward gear, the idler wheel Z1a is connected to the inner countershaft 11 via the shifting unit S1 in a torque-proof manner, whereby the inner input shaft 11 is operatively connected to the outer counter shaft 16. The outer countershaft 16 is additionally connected to the output shaft 13 via the gear wheel plane Z2 and the shifting unit S2, and the third forward gear V3 is formed.

So as to shift from the second forward gear V2 to the third forward gear V3 under a load, one shifts from the first power shift clutch K1 to the second power shift clutch K2 with simultaneous successive opening of the power shift clutch K1 by closing the power shift clutch K2 by the control unit 22. The shifting unit S4 can subsequently be decoupled in a load-free manner.

So as to form the fourth forward gear V4, the inner countershaft 15, which is connected to the outer input shaft 12 via the gear wheel plane E1, is connected to the outer countershaft 16 via the shifting unit S3. By the shifting of the third forward gear V3, the idler wheel Z2a of the second gear wheel plane Z2 is connected to the output shaft 13 via the shifting unit S2, and the outer countershaft 16 is connected to the output shaft 13 via the gear wheel plane Z2. The fourth forward gear V4 is formed.

So as to shift from the third forward gear V3 to the fourth forward gear V4 under a load, one shifts from the second power shift clutch K2 to the first power shift clutch K1 with simultaneous successive opening of the power shift clutch K2 by closing the power shift clutch K1 by the control unit 22. The shift unit S1 can subsequently be decoupled in a load-free manner.

So as to form the fifth forward gear, the inner input shaft 11 is connected to the outer countershaft 16 via the shifting unit S1 and the gear wheel plane E2. By the shifting of the fourth forward gear V4, the outer countershaft 16 is already connected to the output shaft 13 via the second gear wheel plane Z2 and the shifting unit S2, and the fifth gear V5 is formed.

So as to shift from the fourth forward gear V4 to the fifth forward gear V5 under a load, one shifts from the first power shift clutch K1 to the second power shift clutch K2 by closing the power shift clutch K2 with simultaneous successive opening of the power shift clutch K1 by means of the control unit 22. The shifting unit S3 can subsequently be decoupled in a load-free manner.

The sixth forward gear V6 is formed by connecting the inner countershaft 15, which is connected to the outer input shaft 12 via the gear wheel plane E2, to the output shaft 13 via the gear wheel plane Z3 and the shifting unit S3.

So as to shift from the fifth forward gear V5 to the sixth forward gear V6, on shifts from the second power shift clutch K2 to the first power shift clutch K1 by means of the control unit 22 with simultaneous successive opening of the power shift clutch K2. The shifting units S1 can subsequently be decoupled in a load-free manner.

So as to form the seventh forward gear V7, the inner input shaft 11 is connected to the idler wheel Z1a of the third gear wheel plane Z1 in a torque-proof manner via the shifting unit S1. The idler wheel Z1a is again connected to the output shaft 13 via the shifting unit S2, and the seventh forward gear V7, which is designed as a direct gear with a torque-proof connection between the inner input shaft 11 and the outer output shaft 13.

So as to shift from the sixth forward gear V6 to the seventh forward gear V7 under a load, one shifts from the first power shift clutch K1 to the second power shift clutch K2 by means of the control unit 22 by closing the power shift clutch K2 with simultaneous successive opening of the power shift clutch K1. The shifting unit S3 can subsequently be decoupled in a load-free manner.

So as to form the eighth forward gear V8, the inner countershaft 15 is connected to the outer countershaft 16 via the shifting unit S3. By the shifting of the seventh forward gear V7, the idler wheel Z1a is connected to the output shaft 13 via the shifting unit S2, whereby the outer countershaft 16 is connected to the output shaft 13, and the eighth forward gear V8 is shifted.

So as to shift from the seventh forward gear V7 to the eighth forward gear V8 under a load, one shifts from the second power shift clutch K2 to the first power shift clutch K1 by means of the control unit 22 by closing the power shift clutch K1 with simultaneous successive opening of the power shift clutch K2. The shifting unit S1 can subsequently be decoupled in a load-free manner.

So as to form the ninth forward gear V9, the inner input shaft 11 is connected to the outer countershaft 16 via the shifting unit S1 and the gear wheel plane E2. By the shifting of the eighth forward gear V8, the outer countershaft 16 is already connected to the output shaft 13 via the gear wheel plane Z1 and the shifting unit S2, and the ninth forward gear is formed.

So as to shift from the eighth forward gear V8 to the ninth forward gear V9 under a load, one shifts from the first power shift clutch K1 to the second power shift clutch K2 by means of the control unit 22, by closing the power shift clutch K2 with simultaneous successive opening of the power shift clutch K1. The shifting unit S3 can subsequently be decoupled in a load-free manner.

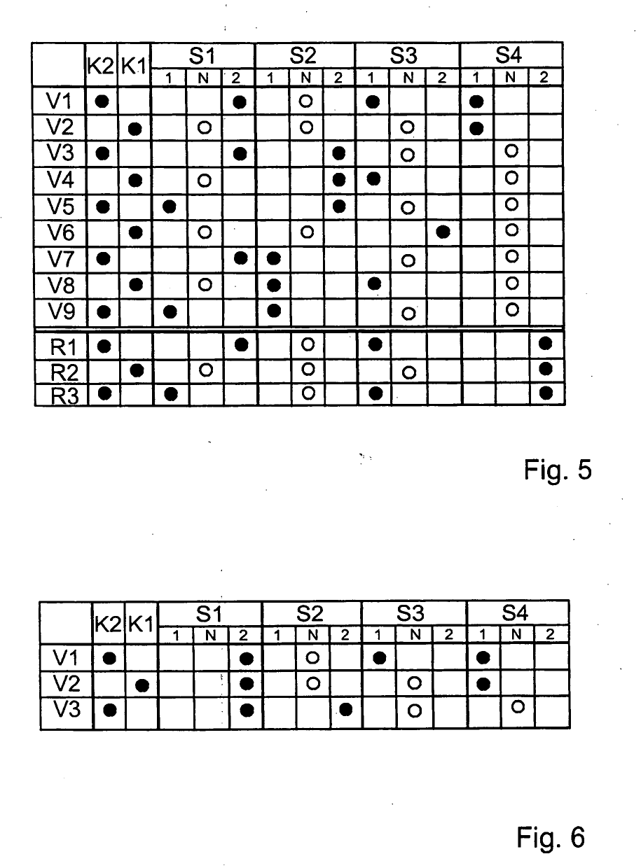

In addition to the sequential shifting processes from one forward gear into an adjacent forward gear, three-way shift processes are also possible under a load with such a shifting logic as shown in FIG. 5. After the described shifting scheme, three way shifting processes from the second to the fifth forward gear V2, V5, from the third to the sixth forward gear V3, V6, and from the sixth to the ninth forward gear V6, V9 are possible, as, with these shifting processes, the corresponding shifting units S1, S2, S3 can be coupled in a load-free manner and subsequently can be shifted under load from the one power shift clutch K2, K1 to the other power shift clutch K1, K2 by successively closing one power shift clutch K2, K1 with a simultaneous opening of the other power shift clutch K1, K2.

The control unit 22 adjusts the shifting logic in dependence on the shifting process to be expected next in certain operating modi. Shifting element actuations from one coupled state 2 into a neutral state N and back into the coupled state 2 during the next shifting process are avoided, and a number of shifting element actuations is thus reduced by omitting shifting element actuations which only lead to a rotary decoupling.

FIG. 6 shows an adjusted shifting logic for an acceleration mode, in which one shifts from the first forward gear V1 to the second forward gear V2, and directly subsequently into the third forward gear V3. After the shifting of the second forward gear V2, it is foregone to decouple the shifting unit S2, as this has to be coupled again for forming the third forward gear V3, and as for forming the first forward gear V1. For a backshift from the third forward gear V3 to the first forward gear V1 via the second forward gear V2, the same shifting logic is used. If it is to be expected that the second forward gear V2 remains coupled for a longer time, losses are minimized by a decoupling of the shifting unit S2 after the shifting of the second forward gear V2, as for example towing losses or ventilation losses by a present necessary relative movement of the second power shift clutch K2.

Analogously, shifting element actuations S2, S3, S4 can also be minimized by an adjusted shifting logic by using an adjusted shifting logic when expecting corresponding shifting processes, for example in a further acceleration mode or in a three way shifting process.

The reverse gears R1, R2, R3 are formed while using the gear wheel plane Z5, which comprises the reversing unit 19 for reversing the rotary direction. So as to form the first reverse gear R1, the inner input shaft 11 is connected to the outer countershaft 16 via the shifting unit S1 and the gear wheel plane Z1. The outer countershaft 16 is additionally connected to the inner countershaft 15 via the shifting unit S3, which countershaft is connected to the output shaft 13 via the gear wheel plane Z5 and the shifting unit S4. The first reverse gear R1 is formed.

The first reverse gear R1 is shifted by closing the power shift clutch K2 successively. The second reverse gear is also formed in principle with the first reverse gear R1, as the outer input shaft 12 is connected to the inner countershaft 15 via the first gear wheel plane E1, which countershaft is again connected to the output shaft 13 via the gear wheel plane Z5 and the shifting unit S4 by means of the shifting of the first reverse gear R1. Thus, one can also start up simultaneously via the first and the second reverse gear R1, R2 by successively closing the associated power shift clutches K1, K2.

So as to shift from the first reverse gear R1 to the second reverse gear R2 under a load, one shifts from the second power shift clutch K2 to the first power shift clutch K1 by means of the control unit 22 by closing the power shift clutch K1 with simultaneous successive opening of the power shift clutch K2. The shifting units S1 and S3 can subsequently be decoupled in a load-free manner.

So as to form the third reverse gear R3, the inner input shaft 11 is connected to the outer countershaft 16 via the shifting unit S1 and the gear wheel plane E2. The outer countershaft 16 is additionally connected to the inner countershaft 15 via the shifting unit S3, which countershaft is already connected to the output shaft 13 by the shifting of the second reverse gear R2 via the gear wheel plane Z5 and the shifting unit S4.

So as to shift from the second reverse gear R2 to the third reverse gear R3 under a load, one shifts from the first power shift clutch K1 to the second power shift clutch K2 by means of the control unit 22 by closing the power shift clutch K2 with simultaneous successive opening of the power shift clutch K1.

A number of shifting element actuations can also be reduced by avoiding shifting element actuations, which only lead to a rotary decoupling of gear wheels, also with the reverse gears R1-R3. A decoupling of the shifting unit S3 in the second reverse gear R2 can especially be foregone.

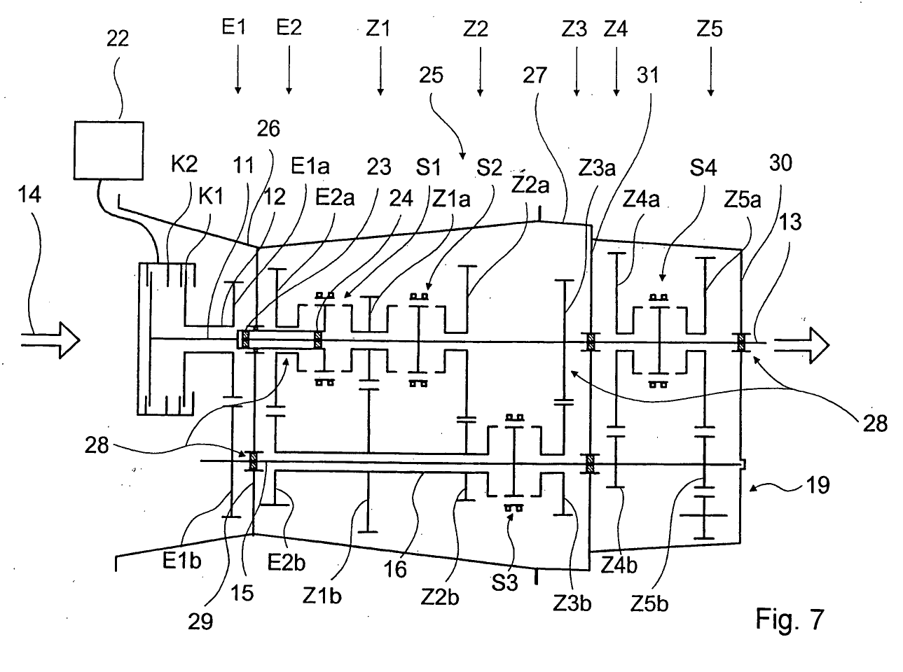

FIG. 7 shows a bearing concept of the variable-speed gear wheel transmission according to the invention. For mounting the input shafts 11, 12 and the output shaft 13 and the countershafts 15, 16, a bearing unit 28 is arranged, which comprises three bearing planes 29, 30, 31. A mounting of the reversing shaft 21 is not shown in detail for simplification.

The output shaft 13 is mounted against the inner input shaft 11 by means of a pilot bearing 23, which is designed as a roller bearing. The pilot bearing 23 is arranged axially on the height of the first gear wheel plane E1, which is on the input side of the second gear wheel plane E2. An additional bearing 24 is arranged on the axial height of the shifting unit S1, which also mounts the inner input shaft 11 against the output shaft 13. An end of the inner input shaft 11 facing the output shaft 13 is therefore designed as a hollow shaft up to an axial height of the first gear wheel plane E1, where the pilot bearing 23 is arranged. The output shaft 13, which is arranged coaxially to the input shafts 11, 12 passes through the end of the inner input shaft 11 designed as a hollow shaft and is mounted at the inner input shaft 11 in a rotatable manner by the pilot bearing 23 and the additional bearing 24.

The input shafts 11, 12, the countershafts 15, 16 and the output shaft 13 are mounted within a transmission housing 25, which consists of two housing parts 26, 27, by means of three bearing planes 29, 30, 31. A first bearing plane 29 is arranged axially between the first and the second gear wheel plane E1, E2. The fixed wheel E1b is therefore mounted in an overhung manner. An arrangement of the first bearing plane 29 between the shifting clutch devices K1, K2 and the first gear wheel plane E1 is alternatively also conceivable. The first bearing plane 29 is designed in one piece with the transmission housing part on the input side and closes off the transmission housing 25 on the input side. A second bearing plane 30 is designed in one part with the transmission housing part 27 on the output side and closes off the transmission housing 25 on the output side. The second bearing plane 30 is arranged on the output side of the seventh gear wheel plane Z5.

A third bearing plane 31, which is designed as a bearing wall, is arranged between the fifth and the sixth gear wheel plane Z3, Z4. The bearing plane 31 designed as a bearing wall is connected to the transmission housing part 27 on the output side of the transmission housing 25 in a fixed manner.

What is claimed is:

1. A gear shift transmission comprising a drive shaft (10), at least two input shafts (11, 12), which can be connected to the drive shaft (10) via at least two power shift clutches (K1, K2), a plurality of gear wheels disposed in gear wheel planes (E1, E2, Z1-Z5), and an output shaft (13), which can be operatively connected to the input shafts (11, 12), said transmission further having at least two sequentially shiftable forward gears (V1, V9) and a shifting device (17), for shifting one of the gear wheel planes (Z1) as an input constant for forming at least one gear (V1, V3) or as a gear wheel pair for forming a further gear (V8, V9), the one gear wheel plane (Z1) comprising an idler wheel (Z1a) , which can be connected to one of the input shafts (11) in a torque-proof manner.

2. The gear shift transmission according to claim 1, wherein the shifting device (17) comprises a shifting unit (S1) for selectively connecting one of the input shafts (11) to one of two idler wheels (E2a, Z1a) in a torque-proof manner.

3. The gear shift transmission according to claim 1, wherein the shifting device (17) comprises a further shifting unit (S2) for connecting one of the two idler wheels (E2a, Z1a) to the output shaft (13) in a torque-proof manner.

4. The gear shift transmission according to claim 2, wherein one of the idler wheels (E2a) is slidingly mounted with regard to one of the input shafts (11).

5. The gear shift transmission according to claim 2, wherein one of the idler wheels (Z1a) is arranged on the output shaft (13).

6. The gear shift transmission according to claim 1, wherein the gear wheel plane (Z1) is an input constant for forming two forward gears (V1, V2) and as a gear wheel pair for forming two of the forward gears (V8, V9).

7. The gear shift transmission according to claim 1, wherein a further gear wheel plane (Z2) is provided as a gear wheel pair for forming three additional of the forward gears (V3, V4, V5).

8. The gear shift transmission according to claim 1, wherein for forming one forward gear (V7) as a direct gear, an idler wheel (Z1a) of the first gear wheel plane (Z1) is connected to one of the input shafts (11) and to the output shaft (13) in a torque-proof manner.

9. The gear shift transmission according to claim 1 including nine forward gears (V1-V9), which are all sequentially load-shifted.

10. The gear shift transmission according to claim 1, wherein the transmission has at least two step ratios (φ_{1/2}, φ_{2/3}) of different size.

11. The gear shift transmission according to claim 10, wherein all step ratios (φ_{1/2}, φ_{3/4}, φ_{4/5}, φ_{5/6}, φ_{6/7}, φ_{7/8}, φ_{8/9}) are smaller in their amount than one step ratio (φ_{1/2}) between the second and the third forward gear (V2, V3).

12. The gear shift transmission according to claim 10, wherein all step ratios (φ_{1/2}, φ_{3/4}, φ_{4/5}, φ_{5/6}, φ_{6/7}, φ_{7/8}, φ_{8/9}) are at least as large as one step ratio (φ_{8/9}) between the two highest forward gear (V8, V9).

13. The gear shift transmission according to claim 1, wherein all step ratios (φ_{1/2}, φ_{3/4}, φ_{3/4}, φ_{5/6}, φ_{6/7}, φ_{7/8}) are larger than the step ratio (φ_{8/9}) between the two highest forward gears (V8, V9) and a step ratio (φ_{4/5}) having the same size in principle between the fourth and the fifth forward gear (V4, V5).

14. The gear shift transmission according to claim 1, wherein the transmission has step ratios (φ_{1/2},−φ_{8/9}) between respectively two adjacent forward gears (V1-V9) which are formed in an approximately constant manner.

15. The gear shift transmission according to claim 1, wherein one end of one of the input shafts (11) which faces the output shaft (13) is in the form of a hollow shaft structure for receiving a pilot bearing (23).

16. The gear shift transmission according to claim 15, wherein the pilot bearing (23) is arranged on the input side of the second gear wheel plane (E2).

17. The gear shift transmission according to claim 16, wherein the input shaft (11) and the output shaft (13) are mounted to each other by an additional bearing (24).

18. The gear shift transmission according to claim 1, including a bearing unit (28) with at least two bearing planes (29, 30, 31), which is provided to mount the input shafts (11, 12) and/or the output shaft (13).

19. The gear shift transmission according to claim 18, wherein the bearing unit 928) comprises three bearing planes (29, 30, 31).

20. The gear shift transmission according to claim 18, wherein at least one of the bearing planes (31) comprises a bearing wall, which is connected to a transmission housing (25) in a fixed manner.

21. The gear shift transmission according to claim 1, wherein the countershaft (16) is formed as a hollow shaft and carries only fixed gear wheels.

22. The gear shift transmission according to claim 1, including a control unit (22) adapted to adjust a shifting logic in depending on shifting processes to be expected, by avoiding in at least one operating mode shifting element actuations of shifting units (S1-S4) from a coupled state (2) into a neutral position (N) and back into the coupled state (2) during the next shifting process.
